(19) United States
(12) Patent Application Publication
(10) Pub. No.: US 2007/0239475 A1
(43) Pub. Date: Oct. 11, 2007

(54) Method of filing a highly repetitive or a jumbo patent application and preparing a patent application

(76) Inventors: Stephan Krieger, Mannheim (DE); Arno Krotzky, Berlin (DE); Gunnar Plesch, Potsdam (DE); Oliver Schmitz, Dallgow-Doberitz (DE); Alfons Weig, Falkensee (DE); Uwe Pressler, Waldsee (DE)

Correspondence Address: CONNOLLY BOVE LODGE & HUTZ, LLP, P O BOX 2207, WILMINGTON, DE, 19899, US

(21) Appl. No.: 11/644,752

(22) Filed: Dec. 22, 2006

Related U.S. Application Data
(60) Provisional application No. 60/753,119, filed on Dec. 22, 2005.

(51) Int. Cl. G06Q 99/00; G06Q 90/00

(52) U.S. Cl. 705/1; 705/500

(57) ABSTRACT

The present invention is generally related to a method to reduce the cost of filing a repetitive or a jumbo patent application. This can be accomplished by using paragraph identifiers and/or summarizing a part of repetitive disclosure in a table format. The present invention also relates to a method to reduce the cost of filing a repetitive or a jumbo patent application which is based on multiple priority applications. The present invention is further related to a method to reduce the cost of filing a subsequent patent application of a repetitive or a jumbo patent application. The present invention is further related to a method to prepare a patent application using automatic text editing process. The subject methods may be used to maximizing the intellectual property protection while minimizing the cost of preparing patent applications and obtaining patent rights.

### RELATED APPLICATIONS

This application claims benefit of U.S. provisional application 60/753,119 filed Dec. 22, 2005. The entire content is incorporated herein by reference.

### FIELD OF THE INVENTION

The present invention is related to a method to reduce the cost of filing a jumbo patent application. The present invention is further related to a method to reduce the cost of filing a subsequent patent application of the jumbo patent application. The present invention is further related to a method to reduce the cost of filing a jumbo patent application which is based on multiple priority applications. The present invention is further related to a method to reduce the cost of filing a subsequent patent application of such a jumbo patent application based on multiple priority applications. The present invention is further related to a method to prepare a patent application.

### BACKGROUND OF THE INVENTION

Very often, patent applications are prepared by combining two or more priority applications. The process of combining priority applications can be sometimes time-consuming and risk-bearing because of the potential of leaving out part of priority disclosure during the preparation. One simple way of preventing the omission of disclosure is to combine together the priority applications one after another without changing any contents. However, some disclosure will then become redundant because of the repetition of same or similar passages in each priority application. Such redundancy would become even more pronounced when the number of priority applications to be combined increases. Consequently, the application size of the final patent application to be filed may become significantly large over 100 sheets of paper, preferably over 150 sheets of paper, preferably over 250 sheets of paper, preferably over 500 sheets of paper, more preferably over 700 sheets of paper, even more preferably over 1,000 sheets of paper, and the application becomes a so-called “jumbo patent application.”

In the United States, according to 35 U.S.C. 41(a)(1)(G) and 37 CFR 1.16(s), if the specification and drawings of a patent application exceed a certain amount of sheets of paper, the application fee due increases for each additional set amount of sheets or fraction thereof. Thus, when a jumbo patent application size increases significantly due to the inclusion of disclosure from multiple priority applications, the application filing cost would significantly increase accordingly. Such increases in the application filing cost accumulatively become burdensome when the filing of subsequent applications of such a jumbo patent application becomes desirable.

Accordingly, there is a need for a method to reduce the cost of filing a repetitive patent application or a jumbo patent application based on multiple priority applications while maximizing the preservation of disclosure from the priority applications. There is also a need for a method to reduce the cost of filing a patent application based on deleting repetitive disclosure in the specification which includes tables. Moreover, there is also a need for a method to reduce the cost of filing subsequent patent applications derived from a jumbo patent application.

In addition to the aforementioned needs in filing a jumbo patent application and its subsequent patent applications, there is also a need for a method of preparing such a large-scale patent application with minimum effort and least errors.

In a large-scale patent application, such as a biotech related application disclosing useful genes, it usually consists of at least two parts. The first part of text describes general background information concerning the invention which is unique to the application. The second part of the text contains paragraphs which are repeatedly used to describe each individual gene, their use for the respective invention, and/or the associated data. As a conventional way of practice, these paragraphs are repeatedly used and only the variable elements which correspond to the individual gene and the data associated therewith are replaced. However, replacing such variable elements in the repeated text paragraphs is a time consuming manual process and prone to errors in the final application text.

This disadvantage may be avoided by replacing manual text editing with an automated text editing process where pre-assembled datasets are inserted at specific position of a master text template. The insertion of individual paragraphs describing one particular gene can be facilitated if the information specific to this gene is retrieved from a database. Such an insertion procedure may be repeated until all information concerning all genes has been entered and incorporated into the text document. As a result of this automated data transfer and incorporation, the risk of manual mistakes may be reduced or even eliminated.

Accordingly, there is a need for such a method to create a patent application using the concept of automated text editing.

### SUMMARY OF THE INVENTION

The present invention provides a new method to reduce the cost of filing a jumbo patent application based on multiple priority applications while maximizing the preservation of disclosure from the priority applications. The present invention further provides a method to reduce the cost of filing subsequent patent applications which are derived from a jumbo patent application.

An important aspect of the present invention is the consideration of maximizing intellectual property protection while minimizing the cost of obtaining patent rights. More specifically, in one variation, the invention comprises a method to reduce the cost of filing a jumbo patent application comprising at least the following: (a) preparing the jumbo patent application by combining multiple priority applications, and (b) reducing the jumbo patent application size by utilizing a new “paragraph identifier” numbering system and the concept of “incorporation by reference.”

By combining the “paragraph identifier” numbering system according to the present invention and the concept of “incorporation by reference,” not only the process of preparing a jumbo patent application based on multiple priority applications may be simplified, but also the disclosure of each priority application may be completely preserved in the jumbo patent application so prepared. More specifically, the jumbo patent application size may be significantly reduced because of the elimination of unnecessary repetition of certain disclosure in the jumbo patent application, a function provided by the paragraph identifier through the concept of “incorporation by reference.” Consequently, the cost of filing such a jumbo patent application may be significantly reduced.

Another important aspect of the invention comprises a method to reduce the cost of filing subsequent patent applications of a jumbo patent application comprising at least the following: (a) reducing the subsequent patent application size by abstracting part of disclosure from the jumbo patent application, and (b) filing the subsequent patent application as a continuing application such as a divisional or continuation-in-part (CIP) application of the jumbo patent application and adding a statement in the divisional or continuation-in-part application that the parent application (jumbo application) is incorporated by reference in its entirety for all useful purposes. More specifically, by including only the portion of the disclosure which is relevant to what may be claimed in the subsequent patent application, the application size of the subsequent patent application may be further reduced as compared to the parent jumbo patent application. As a result, the cost of filing such a subsequent patent application may be significantly reduced.

A further embodiment of the invention is to use additional paragraph identifiers when preparing the jumbo patent application. The additional paragraph identifiers could be helpful for incorporating subject matter by reference without the need to repeat the paragraph(s).

It is yet another aspect of the present invention to further reduce the cost of filing a repetitive patent application or a jumbo patent application and/or subsequent patent applications thereof by summarizing certain disclosure in a table format and re-introducing the disclosure into the specification using the similar concept of “incorporation by reference.” More specifically, the disclosure summarized in a table format may be re-introduced into the specification and the claims where the “incorporation by reference” using “paragraph identifier” according to one aspect of the present invention as described above is not appropriate. As a result, the cost of filing such a repetitive patent application or a jumbo patent application and/or subsequent patent application thereof may be further reduced.

In a further aspect of the present invention, it comprises a method of preparing a biotech-related patent application comprising at least the following: (a) creating a master text template of a patent application, (b) creating a database having a processing tool by loading necessary information into the database, wherein the database comprises biotech-related sequence information, and (c) generating a new patent application based on the master text template by running the processing tool and importing the information from the database to the master text template.

Preferably, the master text template according to the present invention comprises major application blocks and paragraph templates. More preferably, the master text template can further comprise tables. In a preferred embodiment, the paragraph identifier numbering system according to the present invention is used in the master text template. In another preferred embodiment, the paragraph templates in the master text template can further comprise a field identifier. A “field identifier” as used herein provides a paragraph a particular identity according to the specific information disclosed in such a paragraph, such as gene, metabolite, etc. It can be created by surrounding a keyword of such an information with characters such as “%%” (e.g., “%% metabolite %%”).

According to another aspect of the present invention, a new patent application based on the master text template can be created by using the automatic text editing process to incorporate the specific data information from the database into the master text template.

These and other objects, advantages, and features of the invention will become apparent to those skilled in the art upon reading the details of the invention as more fully described below.

### BRIEF DESCRIPTION OF THE DRAWINGS

FIG. 1 demonstrates a simplified version of the experimental background in a large-scale metabolite profiling or performance screening of transgenic plant lines. In one situation, a specific gene can lead to one ore more metabolic changes. For example, the gene A in transgenic plant line A can result in methionine (Met), alanine (Ala) and Glucose change. In another situation, a specific metabolic change can be a result of the activity of different genes. For instance, alanine (Ala) change can be observed in transgenic line A and line B due to the modified gene activity of gene A and gene B, respectively.

FIG. 2 demonstrates an overview of a relational database as described in Example 2 below.

### DETAILED DESCRIPTION OF THE INVENTION

Before the present invention is described in more detail, it is to be understood that this invention is not limited to specific method steps described herein, as such may vary and easily be modified. Thus, the following preferred embodiments are to provide further illustrate the concept and application of the present invention, and is not intended to be limiting the scope of the present invention.

The present invention provides a new method to reduce the cost of filing a repetitive patent application or a jumbo patent application, wherein the method comprises at least the following: (a) preparing the repetitive patent application or the jumbo patent application which covers multiple embodiments that may be considered as a separate and distinct patentable invention or may be restricted out, and (b) filing a continuing application such as a divisional or continuation-in-part application which describes the specific embodiments restricted out of the repetitive patent application or the jumbo patent application by the Examiner and incorporating by reference the complete disclosure of the jumbo patent application.

Another aspect of the present invention provides a new method to reduce the cost of filing a repetitive patent application or a jumbo patent application, wherein the method comprises at least the following: (a) preparing the repetitive patent application or the jumbo patent application by combining multiple priority applications, and (b) filing a continuing application, namely a divisional or continuation-in-part application which describes the specific embodiments or priority application information restricted out of the repetitive patent application or the jumbo patent application by the Examiner and incorporating by reference the complete disclosure of the repetitive patent application or the jumbo patent application.

A further aspect of the invention is reducing the jumbo patent application size by utilizing a new “paragraph identifier” numbering system and the concept of “incorporation by reference.”

As used herein, a “jumbo” patent application refers to a patent application having an application size of at least 50 sheets of paper or patent applications with a high redundancy in its disclosure. The application would include the specification and if drawings are required, the application would include the sheets of drawings. Preferably, the application size is at least 250 sheets of paper. More preferably, the application size is at least 500 sheets of paper. Even more preferably, the application size is at least 750 sheets of paper and even more preferably over 1,000 sheets of paper. The “application size” as used herein refers to the specification and drawings of a patent application, and sequence listing on paper or electronic format, if it is included in the application filing fee calculation. In Europe, a jumbo application would be considered at least 35 sheets of paper.

As used herein, a “jumbo patent application” can also refer to a patent application which is prepared for filing as a nonprovisional patent application by combining multiple priority applications and claiming the priority benefits thereof as long as it meets the sheet requirement by containing at least 50 sheets of paper and more preferably at least 100 sheets of paper. A “priority application” is referred to a patent application of which the priority is based upon in a later patent application. According to the present invention, a jumbo patent application may be prepared by combining at least 2 priority applications, preferably, at least 5 priority applications, more preferably, at least 15 priority applications, or even at least 30 priority applications. Again, a jumbo patent application must preferably contain at least 100 sheets of paper.

As used herein, a “repetitive patent application” does not limit the application to a jumbo application. The repetitive patent application may contain less than 50 sheets of paper as is required by a jumbo application. The repetitive patent application may also be a jumbo patent application. Repetitive patent application or patent applications (in the contest of this application the singular shall embrace the plural and vice versa) in the sense of this application means that parts of the specification, preferably paragraph(s), advantageously marked with an identifier, are identically repeated throughout the specification at different places in the specification.

The invention may be practiced in any countries where the government Patent Office sets its filing fee based on the number of pages of the application, for example at the Patent and Trademark Office of the United States (U.S.P.T.O.), European Patent Office, Japanese Patent Office, Canadian Patent Office or the World International Patent Office (WIPO). In such practices, “jumbo application” refers to a patent application having a number of pages exceeding the maximum number permitted for a base filing fee.

The “paragraph identifier” as used herein refers to a group of symbols such as, but not limited to, numbers, letters, or the like which is assigned to and placed in front of each paragraph to facilitate its identification for the future reference. The paragraph identifier can be after or before an initial sequential paragraph numbering required by a patent office, such as but not limited to the U.S.P.T.O., European Patent Office, Japanese Patent Office, Canadian Patent Office or the World International Patent Office (WIPO). In one embodiment the paragraph identifier would be after the initial sequential paragraph numbering required by the U.S.P.T.O. In one embodiment, the paragraph identifier is used without the initial sequential paragraph numbering required by a patent office, e.g., by the U.S.P.T.O. Additionally, preferably each number within said “paragraph identifier” is associated with a distinct status identification of said paragraph. As used herein, a “paragraph” is referred to a distinct section of written composition that expresses a thought or point relevant to the main theme of the application, but is complete in itself and may consist of one or more blocks of sentences and paragraphs.

According to the present invention, a paragraph identifier is assigned to each paragraph of every priority application before combining them into a jumbo patent application. The paragraph identifier according to the present invention may comprise at least two sets of numbers to provide distinct identification of each paragraph. For example, a paragraph identifier including two sets of numbers may be used to provide a conventional paragraph numbering by the first number and the identity of the priority application to which the paragraph belongs by the second number.

As illustrated herein below, each set of numerous digits within one paragraph identifier provides a distinct function with regards to status identification for the paragraph which follows, such as paragraph numbering, the status of the paragraph as to whether it is modified or newly added, and the origin of the priority application of the paragraph.

In one preferred embodiment, a paragraph identifier according to the present invention may comprise the following elements:

W and Z.

In another preferred embodiment, a paragraph identifier according to the present invention may comprise the following elements:

W and X.

In a preferred embodiment, the paragraph identifier according to the present invention comprises the following further elements:

X and/or Y.

In a further preferred embodiment, the paragraph identifier according to the present invention comprises the following elements:

W, X, Y, and Z, e.g., the paragraph identifier reads [WXYZ],

wherein W, X, Y, and Z represent different set of letters or numerous digits such as Arabic numerals or Roman numbers and can preferably be separated by a separator, such as a period (“.”), colon (“:”), semicolon (“;”), slash (“/”) or backslash (“\”) or a hyphen (“-”) or any other punctuation mark or any other separator. Preferably, the separator is a period (“.”), such as in [W.X.Y.Z]. But it is also possible to use no separator.

W represents the paragraph number in the sense as employed in a conventional way. For example, W may be “0001” for the first paragraph of one priority application, and “0005” for the fifth paragraph of the same priority application.

The order of the elements W, X, Y, and Z is free, i.e., the different placeholder (elements) W, X, Y and Z can be positioned at any places in the row. For example, W can be placed at the beginning or at the end or in between of other elements. Preferably the order is: [W.X.Y.Z].

X represents the status of the paragraph which follows as to whether it is newly added as compared to the priority application. For example, X may be “0” when the paragraph is originally presented in one priority application. Where new paragraphs must be introduced, the paragraph number represented by W stays the same while the number represented by X increases. Thus, [0001.0.Y.Z] may indicate that the first paragraph is originally presented in one priority application, and [0001.1.Y.Z] and [0001.2.Y.Z] may indicate that these are the first two paragraphs newly added following the first paragraph [0001.0.Y.Z] of the same priority application.

Y represents the status of the paragraph which follows as to whether it is modified as compared to the paragraph in the priority application. For example, Y may be “0” when the paragraph is the same as originally presented in one priority application. Where the content of a paragraph must be changed, the number represented by Y may be changed to another number or letter in a given hierarchy, preferably to a number the same as the number represented by Z as described below.

Z represents the identity of the priority application from which the paragraph is originated. For example, the first priority application may be represented as “0,” and the second priority application may be represented as “1,” and so forth. Thus, the first paragraph of the first priority application without any modification may be given a paragraph identifier such as [0001.0.0.0], and the third paragraph of the fourth priority application with some necessary changes may have a paragraph identifier such as [0003.0.1.3]. The hierarchy or order of each element can be chosen freely. The paragraph numbering might start with 0, 1, 2 or any other number or with A, B, C or any other letter.

Accordingly, this paragraph identifier numbering system may be performed in each priority application. Preferably, it is performed in a way that a paragraph containing similar disclosure in each priority application is assigned with same number represented by W. For example, paragraphs where claims and abstract are presented in the first priority application may be assigned as [0234.0.0.0] and [0235.0.0.0], respectively, and claims and abstract in the second priority application may be assigned as paragraphs [0234.0.0.1] and [0235.0.0.1].

Once each paragraph of every priority application is assigned with a proper paragraph identifier, the priority applications may be combined by placing one after another to generate a jumbo patent application. The applications may then be combined according to another important aspect of the present invention using the concept of “incorporated by reference.” Where a disclosure of one paragraph is repeated in some of the priority applications, the disclosure of such paragraph may be replaced by referring to the paragraph identifier of the paragraph where such a disclosure is first presented. In a preferred embodiment, when two priority applications are to be combined, and the paragraphs of the second priority applications are not altered in comparison to the first priority application, the text of those paragraphs in the second priority application is deleted and only a reference to the paragraph identifiers representing those paragraphs in the first priority application is given. For example, when combining two priority applications, if the first paragraph of the second priority application (i.e., [0001.0.0.1]) is the same as the first paragraph of the first priority application (i.e., [0001.0.0.0]), the text is deleted and a reference to the paragraph identifier [0001.0.0.0] is given. Thus, the first paragraph of the second priority application may be presented in the combined application as:

[0001.0.0.1]: see [0001.0.0.0], or

[0001.0.0.1]: for the disclosure of this paragraph see [0001.0.0.0].

In another preferred embodiment, more than two priority applications may be combined based on the same concept. Thus, the text of any paragraph with same disclosure as to the preceding priority application may be substituted with the paragraph identifier of the corresponding paragraph as they appeared in the preceding priority application. For example, if paragraphs 1 through 7 in the third priority application contain the same disclosure as paragraphs 1 to 7 in the first priority application, these paragraphs may be presented as follows:

[0001.0.0.2] to [0007.0.0.2]: see [0001.0.0.0] to [0007.0.0.0].

Similarly, if paragraphs 3 through 5 in the fifth priority application contain the same disclosure as paragraphs 3 to 5 in the second priority application, these paragraphs may be presented as follows:

[0003.0.0.4] to [0005.0.0.4]: see [0003.0.0.1] to [0005.0.0.1].

Virtually, there is no limitation of the amount of priority applications that may be combined into a combined application according to the present invention.

By way of referring to the paragraph identifier instead of repeating the full disclosure, the jumbo patent application size may be reduced significantly due to the elimination of the redundant disclosure. Nevertheless, due to the nature of “incorporation by reference” provided by the paragraph identifier, the disclosure being replaced remains as part of the jumbo patent application. As a result, the cost of filing such a jumbo patent application may be significantly reduced whereas the disclosure of each priority applications may be completely preserved.

According to another aspect of the present invention, the cost of filing a repetitive or a jumbo patent application may be further reduced by summarizing certain disclosure in a table format and re-introducing the disclosure into the specification using the similar concept of “incorporation by reference.” Particularly, where the paragraph identifier as disclosed above is not appropriate to avoid the repetitive disclosure, the repetitive disclosure may be summarized and presented as a table, and the repetitive disclosure may be “incorporated by reference” back to the specification by referring to their location in the table.

For example, in a patent application of biotechnology field containing nucleotide and/or amino acid sequences, each sequence is required to be presented with a sequence identifier number (i.e., SEQ ID NO.). Very often, a large number of sequences are disclosed in a single biotech-related patent application, and the sequence identifier numbers are repetitively used throughout the specification. According to the present invention, the repetition may be effectively reduced by summarizing the sequence identifier numbers in a table format and re-introduced into the specification by referring to their location in the table. For instance, in a patent application with 10 nucleotide sequences (e.g., SEQ ID NOs.: 1, 3, 5, 7, 9, 11, 13, 15, 17, 19), and 10 corresponding amino acid sequences (e.g., SEQ ID NOs.: 2, 4, 6, 8, 10, 12, 14, 16, 18, 20), a conventional way of describing the sequences in the specification may be as follows:

“A nucleic acid comprising a nucleotide sequence of SEQ ID NO: 1, SEQ ID NO: 3, SEQ ID NO: 5, SEQ ID NO: 7, SEQ ID NO: 9, SEQ ID NO: 11, SEQ ID NO: 13, SEQ ID NO: 15, SEQ ID NO: 17, SEQ ID NO: 19.”

Alternatively, it may be simplified as:

“A nucleic acid comprising a nucleotide sequence of SEQ ID NOs: 1, 3, 5, 7, 9, 11, 13, 15, 17, 19.”

According to the present invention, the sequences may be first summarized into a table and re-introduced into the specification by reference to either their column number, row number or any other available identification number. Thus, a patent application combining two priority applications, each containing 10 nucleotide sequences, may be summarized as follows:

TABLE 1
Nucleic acid sequence ID numbers

| | | | 2 | 3 | 4 | 5 |
|---|---|---|---|---|---|---|
| | Appli- | | Lead | Protein | Nucleic acids | Amino acids |
| | cation | 1 | Seq | encoded | Seq Id of | Seq Id of |
| | No. | Organism | Id | (Seq Id) | homologs | homologs |
| 1 | 1 | Homo | 1 | 2 | 3, 5, 7, 9 | 4, 6, 8, 10 |
| | | sapiens | | | | |
| 2 | 1 | Homo | 11 | 12 | 13, 15, 17, 19 | 14, 16, 18, |
| | | sapiens | | | | 20 |
| 3 | 2 | Homo | 21 | 22 | 23, 25, 27, 29 | 24, 26, 28, |
| | | sapiens | | | | 30 |
| 4 | 2 | Homo | 31 | 32 | 33, 35, 37, 39 | 34, 36, 38, |
| | | sapiens | | | | 40 |

Consequently, the sequences may be referred to in the specification as:

“A nucleic acid comprising a nucleotide sequence as indicated in Table 1, columns 2 or 4.”

Alternatively, it may be simplified as:

“A nucleic acid comprising a nucleotide sequence as indicated in Table 1 for application No. 1.”

As the number of the sequences disclosed in an application increases, the application size may be significantly reduced using a similar system according to the present invention. Particularly, the application size may be greatly reduced when the number of sequences is more than 10, preferably, more than 30, more preferably, more than 50, even more preferably, more than 100, further more preferably, more than 200. Virtually, there is no limitation of the number of sequences may be disclosed in a single patent application. It can be understood that, the more sequences disclosed in a patent application, the more advantage of the present invention may be appreciated.

The preservation of disclosure of the priority applications as provided by paragraph identifier as disclosed herein is important to yet another aspect of the present invention where a method to reduce the cost of filing subsequent patent applications based on a jumbo patent application is provided.

According to the present invention, a method to reduce the cost of filing subsequent patent applications of a jumbo patent application comprises at least the following: (a) reducing the subsequent patent application size by abstracting part of disclosure from the jumbo patent application, and (b) filing the subsequent patent application as a continuing application such as a divisional or continuation-in-part (CIP) application of the jumbo patent application.

As used herein, a “subsequent patent application” refers to a patent application which is filed as a “child” application of a jumbo patent application.

Specifically, the application size of a subsequent patent application may be reduced by disclosing only a portion of the parent jumbo patent application which is relevant to what may be claimed in the subsequent patent application. For example, when the subject matter disclosed in one particular priority application becomes more important and requires to be pursued separately as a child application of the jumbo patent application, the portion of disclosure originated from this particular priority application may be abstracted from the jumbo patent application and filed as a continuing application such as a divisional or continuation-in-part application of the jumbo patent application and claims priority benefit thereof.

Following the previous example as an illustration, where the subject matter of the second priority application is to be pursued separately, the portion of disclosure including paragraphs bearing a paragraph identifier with a numerous digit “2” as the element Z may be abstracted from the jumbo patent application and reformed as a child application thereof. Where the disclosure of a paragraph was previously replaced by a paragraph identifier in the course of preparing the jumbo patent application (e.g., “[0001.2]: see [0001.1]” or “[0001.X.Y.2]: for the disclosure of the paragraph see [0001.X.Y.1]”), the full disclosure presented by the referred paragraph identifier (i.e., disclosure of paragraph [0001.1] or [0001.X.Y.1]) maybe reinstalled. Since the disclosure being replaced remains as part of the jumbo patent application due to the nature of “incorporation by reference” provided by the paragraph identifier, the subsequent patent application, although contains reintroduced disclosure, may be nonetheless entitled the priority benefits of the parent jumbo patent application. A child application can be prepared by comprising “incorporation by references” to the parent application, e.g., “[0001.X.Y.2]: the disclosure of the paragraph [0001.X.Y.2] of US 9999,9999 is herein incorporated by reference instead of reinstalling the full text.

Because a significant part of the jumbo patent application is not presented in the subsequent patent application, the application size of the subsequent patent application is significantly reduced as compared to the parent jumbo patent application. Consequently, the cost of filing such a subsequent patent application may be significantly reduced.

This is a very useful procedure to save money in filing a patent application. This also makes it easier for the Examiner to read a jumbo application since the number of pages would be reduced. This is particularly useful in the biotech technology where certain paragraphs must be repeated in order to establish enablement and written description.

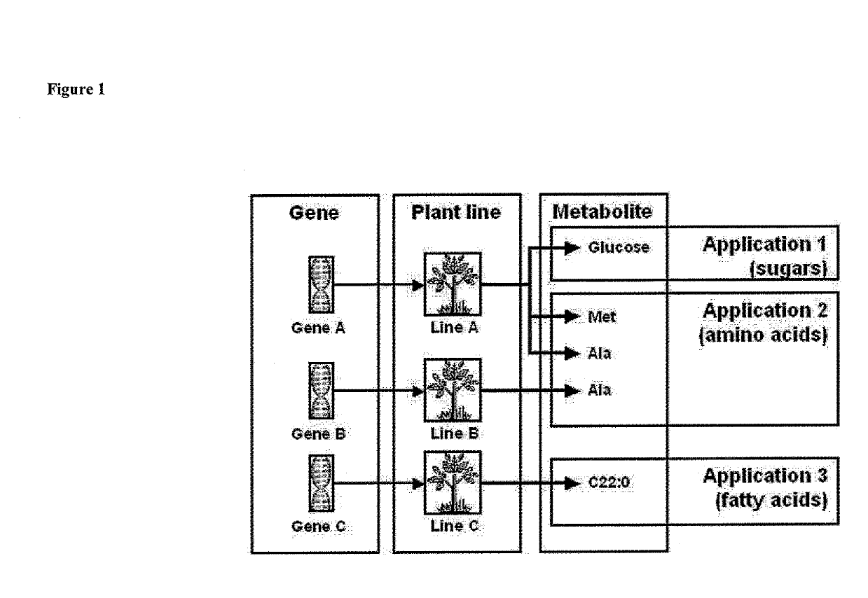

According to another aspect of the present invention, a method of preparing a patent application using the concept of the automated text editing which comprises at least the following steps: (a) creating a master text template of a patent application, (b) creating a database having a processing tool by loading necessary information into the database, wherein the database comprises biotech-related sequence information, and (c) generating a new patent application based on the master text template by running the processing tool and importing the information from the database to the master text template. To facilitate the understanding of the present invention, examples based on large-scale gene and metabolite profiling or performance screening of transgenic plant lines are used in the following description. A simplified experimental background is shown in FIG. 1 and described in the Brief Description of the Drawings. It is to be understood that the examples used herein must be taken as an illustration only and this part of the invention can practically be applied to any patent application containing repetitive information which can be incorporated into the patent application using the method described in the present invention.

As used herein, the “master text template” refers to a patent application template which is prepared based on any conventional ways. Repeating paragraphs that are present in every patent application derived from such a template document should be replaced with a single generalized text. Paragraphs that are various between patent applications can be replaced with a special mark-up language field which allows the repeating text constructs be defined on several levels, such as application, block, or particular subject matter such as lead gene and metabolite. Each of these paragraphs can be marked with a paragraph identifier as described above.

A master text template of a patent application according to the present invention may comprise the following part: major application blocks, paragraph templates, inserting tables, and disclosure information for paragraphs.

As used herein, “major application block” means the distinct major blocks in a patent application text. In the master text template they can be marked with paragraph identifiers as described above. Inside these major blocks several text paragraphs can be included, each describing a specific part of the invention, e.g., a lead gene.

According to the present invention, each paragraph in the template can describe a number of similar application paragraphs. The processing tool will then iterate through a database, duplicating the template text and replacing marked varying fields with appropriate description or values corresponding to the particular field. Field identifiers can be surrounded with characters such as “%%,” for example, %% metabolite %%.

The mark-up language has also a possibility to combine information such as a metabolite information and other related information in various ways. This is used in paragraphs where one type of information is connected with several data from another class. For example, when one individual lead gene is involved in the production of several metabolites, a combination of metabolites shall be described rather than one single metabolite. Thus, in one particular application where an increase of the content of methionine, alanine, and valine has been observed for an individual gene, the mark-up language gives the following three possible expressions in the application text: “methionine, alanine and valine”, “methionine, alanine or valine”, “methionine, alanine and/or valine.” Such combinations are dynamically created by linking the metabolites to a specific application number, and no user action is necessary to create these expressions.

In addition to repeat major paragraphs several times with distinct data, table may be created to overview the specific data instead of repeating the entire paragraph. To create such a table, the dataset corresponding to a specific application is entered into and presented as a table and insert into a defined location within the paragraph text body.

The text editing tool as described herein also facilitates the “incorporated by reference” step as described above when combining several priority applications to generate a jumbo patent application. As described above, when two priority applications are to be combined, the repeated disclosure in the second priority application will be replaced with a disclosure notice by referring to the paragraph identifier of the first priority application where the same disclosure is described. By detecting the presence or absence of variable field identifiers in the paragraphs, the text editing tool as disclosed herein has the capability to determine whether a full-length disclosure is required or a disclosure notice mode can be used. No other specific marking is necessary for such paragraphs.

As a second step of the present invention in preparing a patent application, all the necessary information such as lead gene and metabolite related specific data should be loaded into a database (e.g., a relational database) having a processing tool and combined with application specific information such as application number and application group. Expressions or phrases necessary to be inserted into the text template can be defined in the database (e.g., gene, or metabolite class such as “amino acids” or “sugars”). Data entered into the database can consist of various information. As used herein, the “processing tool” means a computer program or software which has the capability to import information from a database into a text file. A common processing tool which is useful for the present invention is PatentTool. A preferred embodiment demonstrating more detail concerning the organization of different types of information in the database is provided in the Example 2 as an illustration.

Once the information is entered into the database, an application document can be created based on the master text template by running the processing tool and importing the information from the database to the master text template. During this step, the processing tool will identify the beginning of a major paragraph block by searching for paragraph identifiers. The end of a major paragraph block is reached if another paragraph identifier is detected.

The number of iterations for each paragraph depends on the field identifier and the number of respective entries in the database. For instance, if one application consists of 5 lead genes, and each lead gene related to 8 independent metabolic changes, a paragraph containing only the lead gene field identifier would be repeated five times, whereas a paragraph containing a combination of a lead gene field identifier and a metabolite field identifier would be repeated 8 times.

In addition to the automatic text editing capabilities, the processing tool according to the present invention also allows the creation of tables summarizing the sequence information appended to each single priority application or a PCT application.

Furthermore, the text editing tool according to the present invention can also allow additional sequence information that might become available prior to the filing of an application to be added to the relational database, and thus updated text documents or tables can be generated at any time.

While the present invention has been described with reference to the specific embodiments and examples, it should be understood that various modifications and changes may be made and equivalents may be substituted without departing from the true spirit and scope of the invention. The specification and examples are, accordingly, to be regarded in an illustrative rather then a restrictive sense.

### EXAMPLES

### Example 1

### Filing Subsequent Applications of a Jumbo Application

An example could be a plant biotech application containing over 2,500 pages claiming benefits to over 20 different priority documents describing over 20 different genes. See for example, PCT/EP/2005/007080 filed Jun. 29, 2005 which is incorporated by reference in its entirety for all useful purposes. Each priority document may disclose the discovery and/or application of one gene application. There can be two priority applications covering the same gene used in different organism. Therefore, there could be 40 priority applications filed within one year with each priority application containing approximately 350 pages. However, for each gene application there would be numerous repetitive sections. By incorporating the paragraph identifiers into the jumbo patent application, this would significantly reduce the number of sheets of paper in the jumbo patent application.

If a divisional application is filed on one of the gene applications, the divisional application can be prepared by only abstracting the necessary information for the one gene priority application from the jumbo patent application and incorporating the rest of the jumbo patent application by reference in its entirety for all useful purposes. Incorporating the text of the jumbo patent application by reference would permit the divisional application to be amended in case some information that is later deemed critical to the divisional application was inadvertently omitted from the divisional application.

### Example 2

### Generating a Relational Database for the Preparation of a Patent Application Using the Automatic Text Processing Tool

In the second step during the preparation of a patent application using the automatic text processing tool, the necessary information such as lead gene and data related to metabolite information should be entered into a database in combination with information specific to each application (e.g., application number and application group). The data provided to the database can consist of the following tables. Note that not all data presented in this example must be used to prepare the text template.

The first table can consist of gene specific information, which can be an output file from another tailored database. This table can contain a list of primary sequences and all types of associated sequences (e.g., homologs, primers, consensus/patterns) in a large one-dimensional table with the sequence identifier (i.e., SEQ ID NO., “Seq ID”) associated with each sequence type.

For example, the following can be used as the column description of such a table:
WIPO Seq ID
Organism
Taxon ID
Molecule type
Class
Patent pool name
Primary sequence name (lead gene)
Sequence name
WIPO 222
WIPO 223
Original DB Accession number
Description
Sequence length
Percentage identity with primary
Percentage similarity with primary
Homtype
Sequence

The second table can consist of SeqID information which can be an output file from another database such as the software PatentTool. This table can contain the link between SeqID of the lead gene and the SeqID of homologs, primers, consensus/patterns, etc. in a line-specific format.

For example, the following can be used as the column description of such a table:
ID
Application-No.:
Project-No.:
Accession-No. (lead gene)
Organism
NS lead SEQ ID
Metabolite
Nucleic acids SEQ IDs of
Homologs

The third table can consist of gene associated information such as metabolic information which can be provided by the project. This table can contain a list of lead genes and the observed metabolic changes. In addition, this table can also contain other relevant data depending in the nature of the respective experiment (e.g., growth performance data under stress conditions).

For example, the following can be used as the column description of such a table:
ORF (lead gene)
Metabolite
Method/Analytics
Min.-Value
Max.-Value

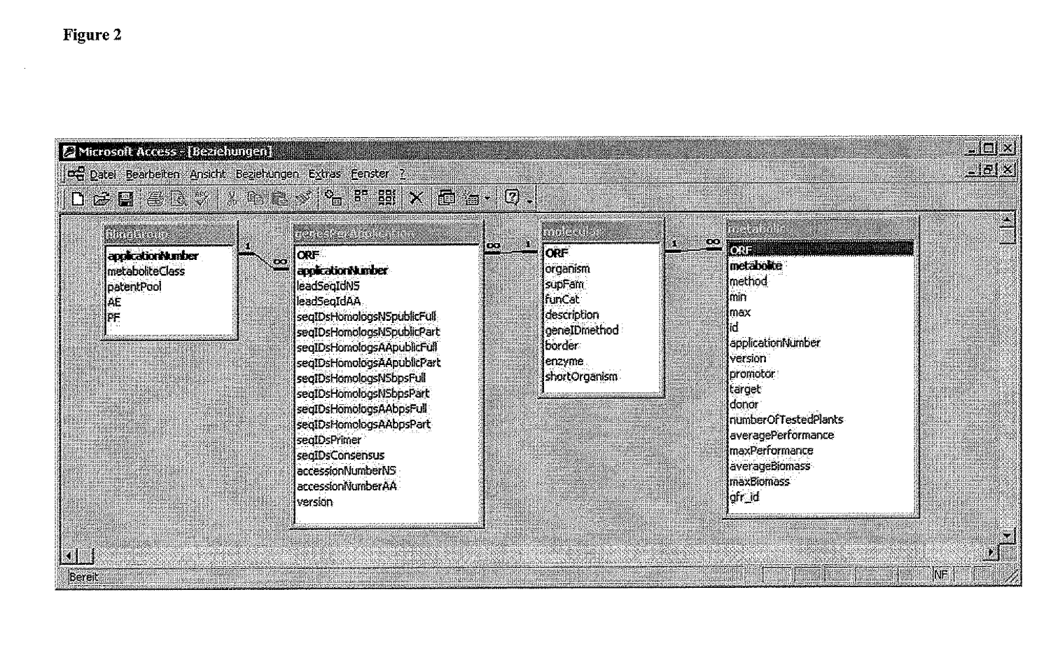

The individual data sets of the three tables described above are linked together by the lead gene. As demonstrated in FIG. 2, an (internal) application number is assigned to each of these relational data which links the experimental data set of the three tables as described above to a specific application information.

We claim:

1. A method to reduce the cost of preparing a continuing application from a patent application comprising:
(a) preparing the patent application,
(b) filing the patent application in a Patent Office of a desired country,
(c) receiving a restriction or lack of unity requirement from the Patent Office which groups the subject matter into at least two groups of claims and
(d) preparing the continuing application by incorporating the subject matter of non-elected invention into the continuing application and deleting the subject matter of the elected invention from the application thereby reducing the number of sheets of the application.

2. The method as claimed in claim 1, wherein the continuing application is a divisional application.

3. The method as claimed in claim 1, wherein the continuing application is a continuation-in-part application.

4. The method as claimed in claim 2, wherein said patent application is a jumbo patent application and which further requires adding a section in the continuing application which incorporates by reference in its entirety the jumbo patent application.

5. The method as claimed in claim 1, wherein the patent application is a jumbo patent application and further comprising preparing the jumbo patent application by replacing the repetitive disclosure with a paragraph identifier.

6. The method as claimed in claim 5, wherein the paragraph identifier comprises elements
W and X,
wherein W and X, represent different set of symbols, and
W represents the paragraph number of the priority application and
X represents the status of the paragraph which follows as to whether it is newly added as compared to the priority application.

7. The method as claimed in claim 5, wherein the paragraph identifier comprises elements W and Z,
wherein W and Z, represent different set of symbols, and
W represents the paragraph number of the priority application and
Z represents the identity of the priority application filed.

8. The method as claimed in claim 5, wherein the paragraph identifier comprises elements W, X, Y and Z,
wherein W, X, Y, and Z represent different set of symbols, and
W represents the paragraph number of the priority application,
X represents the status of the paragraph which follows as to whether it is newly added as compared to the priority application,
Y represents the status of the paragraph which follows as to whether it is modified as compared to the paragraph in the priority application, and
Z represents the identity of the priority application filed.

9. The method as claimed in claim 1, further comprising preparing the application by summarizing a part of repetitive disclosure in a table format and replacing the part of repetitive disclosure in the specification by referring to their location in the table.

10. The method as claimed in claim 1, wherein said Patent Office is the United States Patent and Trademark Office, the European Patent Office, the Japanese Patent Office, the Canadian Patent Office or the World International Patent Office.

11. A method of preparing a patent application by reducing the total amount of pages which comprises:
abstracting a portion of disclosure from the patent application by replacing the repetitive disclosure with a paragraph identifier wherein said paragraph identifier incorporates subject matter of a previous paragraph by reference without adding the repetitive section.

12. The method as claimed in claim 11, which further comprises preparing a continuing application by incorporating the subject matter of non-elected invention into the application and deleting the subject matter of the elected invention from the application thereby reducing the number of sheets of the application.

13. The method as claimed in claim 12, wherein the continuing application is a divisional application and the patent application is a jumbo patent application.

14. The method as claimed in claim 12, wherein the continuing application is a continuation-in-part application and the patent application is a jumbo patent application.

15. The method as claimed in claim 12, wherein said patent application is a jumbo patent application and which further requires adding a section in the continuing application which incorporates by reference in its entirety the jumbo patent application.

16. The method as claimed in claim 11, wherein the paragraph identifier uses the format WX wherein W and X, represent different set of numerous digits and are optionally separated by a separator and
W represents the paragraph number of the priority application, and
X represents the status of the paragraph which follows as to whether it is newly added as compared to the priority application.

17. The method as claimed in claim 11, wherein the paragraph identifier uses the format WZ wherein W and Z, represent different set of numerous symbols and are optionally separated by a separator and
W represents the paragraph number of the priority application, and
Z represents the identity of the priority application filed.

18. The method as claimed in claim 11, wherein the paragraph identifier uses the format WXYZ,
wherein W, X, Y, and Z represent different set of numerous digits and are optionally separated by a separator, and
W represents the paragraph number of the priority application,
X represents the status of the paragraph which follows as to whether it is newly added as compared to the priority application,
Y represents the status of the paragraph which follows as to whether it is modified as compared to the paragraph in the priority application, and
Z represents the identity of the priority application filed.

19. The method as claimed in claim 11, further comprising preparing the jumbo application by summarizing a part of repetitive disclosure in a table format and replacing the part of repetitive disclosure in the specification by referring to their location in the table.

20. The method as claimed in claim 11, wherein said patent application is a jumbo patent application.

21. A method to reduce the cost of filing a patent application comprising:
(a) preparing the patent application,
(b) summarizing a part of repetitive disclosure in a table format, and
(c) replacing the part of repetitive disclosure in the specification by referring to their location in the table.

22. The method as claimed in claim 21, which further comprises preparing a continuing application by incorporating the subject matter of non-elected invention into the application and deleting the subject matter of the elected invention from the application thereby reducing the number of sheets of the application.

23. The method as claimed in claim 22, wherein the continuing application is a divisional application.

24. The method as claimed in claim 22, wherein the continuing application is a continuation-in-part application.

25. The method as claimed in claim 22, wherein said patent application is a jumbo patent application and which further requires adding a section in the continuing application which incorporates by reference in its entirety the jumbo patent application.

26. The method as claimed in claim 21, which further requires comprises:
abstracting a portion of disclosure from the patent application by replacing the repetitive disclosure with a paragraph identifier wherein said paragraph identifier incorporates subject matter of a previous paragraph by reference without adding the repetitive section.

27. The method as claimed in claim 26, wherein the patent application is a jumbo patent application.

28. The method as claimed in claim 26, wherein the paragraph identifier uses the format WX wherein W and X, represent different set of numerous symbols and are optionally separated by a separator and
W represents the paragraph number of the priority application, and
X represents the status of the paragraph which follows as to whether it is newly added as compared to the priority application.

29. The method as claimed in claim 26, wherein the paragraph identifier uses the format WZ wherein W and Z, represent different set of numerous symbols and are optionally separated by a separator and
W represents the paragraph number of the priority application, and
Z represents the identity of the priority application filed.

30. The method as claimed in claim 26, wherein the paragraph identifier uses the format WXYZ,
wherein W, X, Y, and Z represent different set of numerous digits and are optionally separated by a separator and
W represents the paragraph number of the priority application,
X represents the status of the paragraph which follows as to whether it is newly added as compared to the priority application,
Y represents the status of the paragraph which follows as to whether it is modified as compared to the paragraph in the priority application and
Z represents the identity of the priority application filed.

31. A method of preparing a biotech-related patent application comprising:
(a) creating a master text template of a patent application,
(b) creating a database having a processing tool by loading necessary information into the database, wherein the database comprises biotech-related sequence information, and
(c) generating a new patent application based on the master text template by running the processing tool and importing the information from the database to the master text template.

32. The method of claim 31, wherein the master text template comprises at least major application blocks and paragraph templates.

33. The method of claim 32, wherein the master text template further comprises one or more tables.
